(19) United States
(12) Patent Application Publication
(10) Pub. No.: US 2019/0370411 A1
(43) Pub. Date: Dec. 5, 2019

(54) ROTATING PROBABILISTIC DATA STRUCTURE

(71) Applicant: SAP SE, Wallforf (DE)

(72) Inventor: Alexandre Rojkov, North Vancouver (CA)

(21) Appl. No.: 15/996,072

(22) Filed: Jun. 1, 2018

(51) Int. Cl. G06F 17/30; G06N 7/00

(52) U.S. Cl. CPC G06F 17/30967; G06N 7/005; G06F 17/30979

(57) ABSTRACT

In one embodiment, a method uses a first probabilistic data structure to determine whether queries have been previously received during a first time period. Data from a first storage device is retrieved to satisfy a query and stored in a second storage device when information in the first probabilistic data structure indicates the query is repeated. Within the first time period, the method trains a second probabilistic data structure while the first probabilistic data structure is being used to determine whether queries have been previously received. Information in the second probabilistic data structure is set for the queries to indicate the second set of queries have been received. Upon an end of the first time period, the method replaces the first probabilistic data structure with the second probabilistic data structure. The second probabilistic data structure is used to determine whether queries have been previously received for a second time period.

### BACKGROUND

Applications use caching to deliver data more efficiently at the cost of using more memory. For example, if an application caches data from a database in local storage (e.g., cache memory), when the application receives a query for that data, the application can provide the data from the local storage instead of from the database. The advantage of providing the data from the local storage is that the application can most likely respond to the query much more quickly than accessing the data in the database. However, storing the data in both the database and the local storage uses more memory. To make memory use more efficient, the application may attempt to implement a caching solution that stores only items that are repeatedly requested in the local storage.

A Bloom filter is a probabilistic data stricture that helps determine if an item exists in a set. For example, a system can use a Bloom filter to determine whether or not a query has been received before. When a query is received, the system applies an algorithm, such as a hash function, to parameters for the query to generate a key, such as a hash value, for the Bloom filter. If the resulting key is found in the Bloom filter, the application determines that the query has been seen before. In some cases, the application may store the data from the database for the query in the local storage because the query is being repeated.

The algorithm used by the Bloom filter to generate the keys is probabilistic and false positives are possible and become more probable as the size of the item set grows. That is, because a hash value compresses the item set to a smaller set of keys, as more queries are received and keys are generated, the probability that a false positive results increases. A false positive is where the Bloom filter indicates that the query has been seen before, but in reality, the query has not been seen before. As different queries may produce the same key, the Bloom filter will eventually start producing more false positives as the item set increases, which will negate the effect of using the Bloom filter because the local storage will not be using storage as efficiently as possible.

### BRIEF DESCRIPTION OF THE DRAWINGS

FIG. 1 depicts a simplified system for providing a rotating Bloom filter according to some embodiments.

FIG. 2 depicts a simplified flowchart of a method for using the Bloom filter according to some embodiments.

FIG. 3 depicts a simplified flowchart of a method for training a second Bloom filter according to some embodiments.

FIG. 4A shows an example of a first Bloom filter before the training process starts according to some embodiments.

FIG. 4B shows an example of a second Bloom filter before the training process starts according to some embodiments.

FIGS. 5A and 5B show an example of the first Bloom filter and an example of the second Bloom filter during the training process according to some embodiments.

FIG. 6 depicts an example of the second Bloom filter after the training process ends according to some embodiments.

FIG. 7 depicts an example showing the training time periods according to some embodiments.

FIG. 8 illustrates hardware of a special purpose computing machine configured with a query processor according to one embodiment.

### DETAILED DESCRIPTION

Described herein are techniques for a storage system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

A system uses a probabilistic data structure, such as a Bloom filter, to determine whether or not a query has been previously received within a time period. To keep the state of the Bloom filter up to date, a query processor may periodically use a new instance of the Bloom filter. For example, a first Bloom filter may be used during a first time period and then a second Bloom filter will replace the first Bloom filter when the first time period ends, which starts a second time window.

Just replacing the first Bloom filter with the second Bloom filter where the second Bloom filter has no values that are set means the second Bloom filter has no record of any queries that have been previously received. That is, any queries received before the second time period starts will not be represented in the second Bloom filter. Thus, the efficiency of using local storage to service queries that were previously received is lost when the second Bloom filter replaces the first Bloom filter because the computing system considers all queries that are now received to be the first time those queries are encountered. To avoid this problem, some embodiments start training the second Bloom filter before the first time period ends. During training, when a query is received and a key is generated from the query for insertion in the first Bloom filter, the same key is inserted in the second Bloom filter. Thus, when it is time for the second Bloom filter to replace the first Bloom filter, the second Bloom filter includes keys for some of the most recent queries that were received during the training period. However, older queries that have not been recently received are not reflected in the second Bloom filter. Accordingly, using the training period improves the operation of the system because the Bloom filter does not continue to grow in size where more false positives result. Rather, the second Bloom filter reflects queries that have been most recently received and may be repeated, but other older queries that may not be repeated in the future are not reflected in the second Bloom filter. This may reduce false positives while still allowing the second Bloom filter to be used to determine when recent queries have been repeated.

System

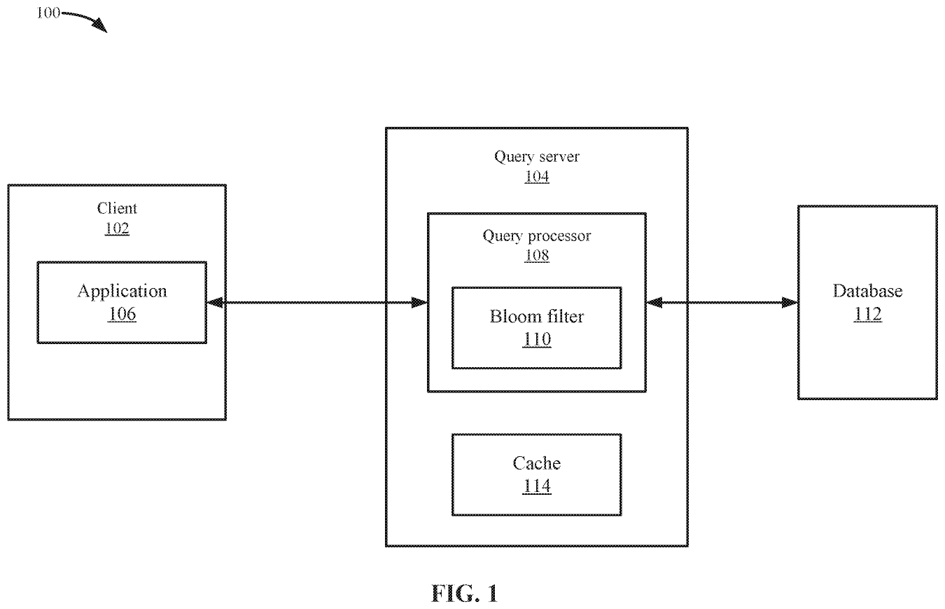

FIG. 1 depicts a simplified system 100 for providing a rotating Bloom filter according to some embodiments. System 100 includes a client 102, a query server 104, and a database 112. Client 102 may be using an application 106 to access data stored in database 112 and query server 104 may process queries for the data. Although this system of accessing data in database 112 is discussed, other configurations may be appreciated. For example, functions performed by query server 104 may be distributed to other devices.

Application 106 may be any application that is accessing data in database 112. Database 112 may store data in a structured format, such as in database tables that are accessed using database queries that include parameters to access the data. The process for accessing data in database 112 is performed through query server 104. For example, a query processor 108 receives a query from application 106, and processes parameters of the query to determine which data in database 112 to retrieve. Processing the query takes time to communicate with database 112 to retrieve the data because database 112 is typically connected to query server 104 via an external network. Typically, it would be faster for query processor 108 to retrieve the data for the query if the data was stored in local storage, such as cache 114. For example, cache 114 may be stored locally to query server 104, such as in memory. Although cache 114 may be in memory storage, cache 114 may also be other types of storage devices, such as locally connected storage, that are accessible faster than accessing data in database 112. Accordingly, retrieving the data in cache 114 takes less time than communicating via an external network to database 112.

Query processor 108 includes a Bloom filter 110. Query processor 108 receives a query and can use a function or algorithm for Bloom filter 110, such as a hash function, to generate a key, such as a hash value, from parameters of the query. Query processor 108 can then insert the key into Bloom filter 110. The function used to generate the key takes the parameters as input and generates a key based on the parameters. The key represents the query, such as the function will generate the same key for the same query with the same parameters.

Query processor 108 can use Bloom filter 110 to determine when queries are repeated. For example, query processor 108 receives a query, generates a key, and if the query was not received before, inserts the key into the Bloom filter 110. Then, if query processor 108 receives a query and the key for that query is in the Bloom filter 110, query processor 108 determines that this query has been repeated. Because this query is being repeated, it may be more likely that the query will be repeated in the future and response times will be quicker if data for the query from database 112 is stored in cache 114. The next time this query is received, query processor 108 determines the key for the query is in Bloom filter 110 and can retrieve the data from cache 114.

Bloom filter 110 is a probabilistic data structure that is used to test whether an element is a member of a set. A probabilistic data structure may use hash functions to randomize and compactly represent a set of items. Bloom filter 110 may include false positives, but false negatives are not possible. That is, Bloom filter 110 can return whether a query has not been seen before, but can return that a query has possibly been seen before. As discussed above, it is possible that the function will generate the same key for different queries. Thus, it is possible that the function may produce false positives, where different parameters are input into the function, but the function outputs the same key. When a query that has not been received before corresponds to the same key as a query that was received before, this is considered a false positive. The false positives negate the benefits of using Bloom filter 110 and as the number of queries being processed by query processor 108 increases and more keys are inserted into Bloom filter 110, the odds of a false positive happening increase. Accordingly, some embodiments improve the use of Bloom filter 110 by rotating Bloom filters where a first Bloom filter 110 is replaced by a second Bloom filter 110. The use of the new Bloom filter 110 decreases the number of false positives because the item size is limited by rotating in new Bloom filters 110. Although a Bloom filter is described, other probabilistic data structures may be used, such as Count-min sketch.

The use of rotating Bloom filters 110 may reduce the number of false positives; however, if a second Bloom filter 110 is started as an empty data structure, then query processor 108 is starting over in determining whether queries have been received before. That is, an empty Bloom filter means that query processor 108 cannot be used to determine if any queries have been received before. Thus, a query that was received when the first Bloom filter 110 was being used would not be represented in the second Bloom filter 110. To improve this process, some embodiments train the second Bloom filter 110 before the time period in which the second Bloom filter 110 is scheduled to be used by query processor 108.

When training the second Bloom filter 110, query processor 108 uses the first Bloom filter 110 to process queries. That is, query processor 108 receives a query, generates a key, and if the query was not received before, inserts the key into the first Bloom filter 110. Also, if query processor 108 receives a query and the key for that query is in the first Bloom filter 110, query processor 108 can check whether data for the query from database 112 in already stored in cache 114. If so, query processor 108 retrieves the data from cache 114 and provides the data to client 102. If the data is not already stored in cache 114 query processor 108 can store data for the query from database 112 in cache 114. Also, when training second Bloom filter 110, query processor 108 inserts any key generated by query processor 108 into second Bloom filter 110. For example, if the query was not received before, query processor 108 inserts the key into the first Bloom filter 110 and also the second Bloom filter 110 that is being trained. Also, if query processor 108 receives a query and the key for that query is in the first Bloom filter 110 query processor 108 still inserts the key into the second Bloom filter 110.

Using the above training, query processor 108 can rotate Bloom filters 110 while still maintaining recent records for queries that have been previously received. The rotating efficiently uses cache 114 by storing data in cache 114 for queries that have been repeated. Queries that were not repeated during the training of the new Bloom filter 110 would not be included in the new Bloom filter 110. However, since the query has not been repeated in a recent time period, it is possible that these queries will not be performed again or are queries that are no longer being repeated. Thus, the efficiency that may be lost by not including these queries from prior to the training period may not be great; however, the reduction of false positives may be significant.

Using the Bloom Filter

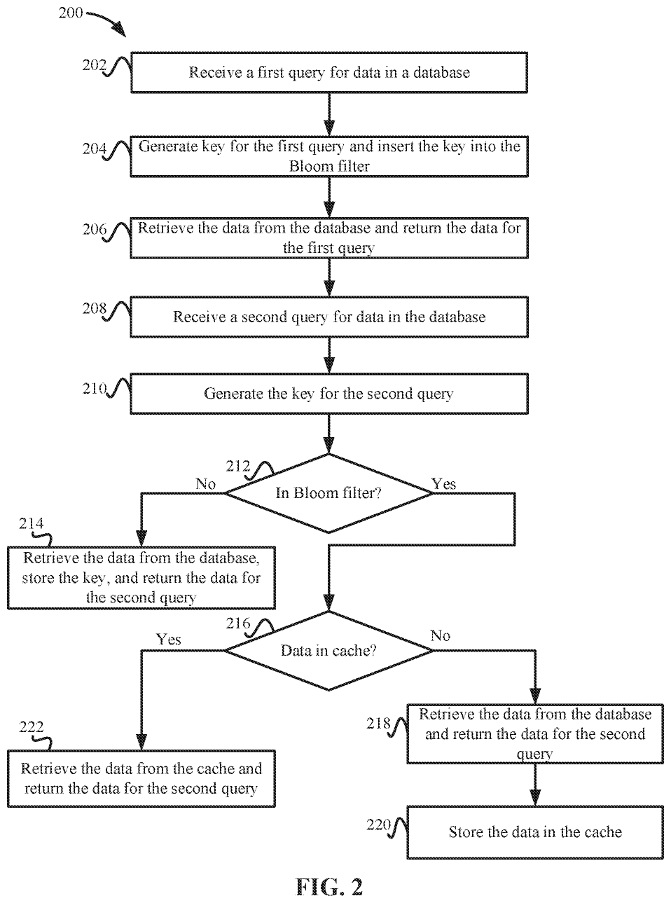

FIG. 2 depicts a simplified flowchart 200 of a method for using Bloom filter 110 according to some embodiments. The following describes the use of Bloom filter 110 by query processor 108. The training process will be described thereafter.

At 202, query processor 108 receives a first query for data in database 112. For example, application 106 may send a query for data in database 112. The query may include parameters that are used to retrieve data from database 112. The parameters may include any information identifying data in database 112.

At 204, query processor 108 generates a key using the parameters for the first query and inserts the key into Bloom filter 110. As discussed above, query processor 108 may use a function, such as a hash function, that receives the parameters for the query as input and generates a key based on the values of those parameters. This process is assuming that the query has not been seen before.

Because query processor 108 has not seen this query before, query processor 108 retrieves the data from database 112 at 206 using the parameters of the query and returns the data for the first query to application 106. The retrieving of the data may require query processor 108 to communicate with database 112 through a network. The communication through the network to retrieve the data takes a first amount of time.

At 208, query processor 108 receives a second query for data in the database. The second query may include the same parameters as the first query or different parameters. At 210, query processor 108 generates a key for the second query using the function. If the second query includes the same parameters as the first query, then query processor 108 would generate the same key as the first query. If the second query includes different parameters than the first query, then query processor 108 may generate a different key.

At 212, query processor 108 determines if the key is found in Bloom filter 110. If the key is not in Bloom filter 110, the process continues at 214 where query processor 108 retrieves the data from the database, stores the key, and returns the data for the second query to application 106. This is similar to the process described in the process at 202, 204, and 206.

However, if the key was in Bloom filter 110, at 216, query processor 108 determines if the data is stored in cache 114. Because the key is stored in cache 114, query processor 108 knows that the query has been received before. Two situations may result: either the second query have been received once before (e.g., the data is not in cache 114) or has been received more than once before (e.g., the data is in cache 114). When query processor 108 determines that a key is in Bloom filter 110, query processor 108 may first check cache 114 to determine whether data for the key has been already stored in cache 114.

If the data is not in cache 114, at 218, query processor 108 retrieves the data from database 112 and returns the data for the second query to application 106. Because this query has been repeated, query processor 108 may expect that this query may continue to be repeated and it may be efficient to store the data in cache 114 for faster access. At 220, query processor 108 stores the data in cache 114.

If the data was stored in cache 114, which may mean that the query has been received more than twice, at 222, query processor 108 retrieves the data from cache 114 and returns the data for the second query to application 106. Query processor 108 may determine whether or not the data is stored in cache 114 by using the key and determining if any data for the key has been stored in cache 114. The data in cache 114 may be indexed by keys that are generated for the queries. Thus, if data for a key has been stored in cache 114, query processor 108 can look up to see whether cache 114 includes the key.

Retrieving the data from cache 114 does not retrieve the data from database 112. That is, the time to retrieve data from cache 114 is shorter than the first time period to retrieve data from database 112. Because accessing cache 114 is quicker than accessing data in database 112, query processor 108 can process the query faster using the data from cache 114.

Training of the Bloom Filter

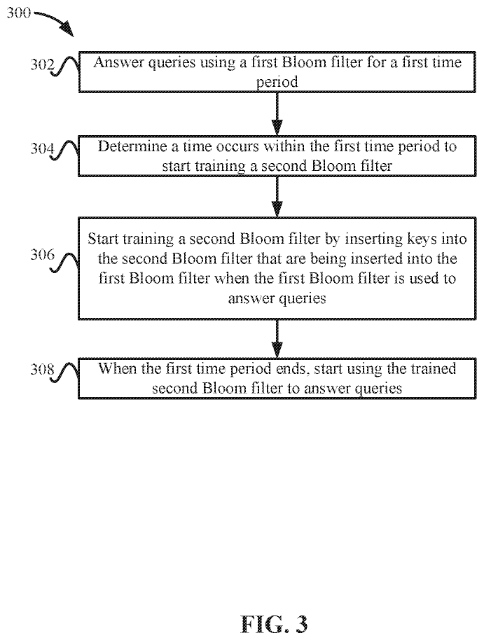

FIG. 3 depicts a simplified flowchart 300 of a method for training a second Bloom filter 110 according to some embodiments. At 302, query processor 108 answers queries using a first Bloom filter 110 for a first time period. The first time period may be a set time period, such as 1 hour, multiple hours, 1 day, multiple days, 1 week, etc. The processing using the first Bloom filter 110 may be as described above in FIG. 2.

At 304, query processor 108 determines that a time occurs within the first time period to start training a second Bloom filter 110. The time is before the first time period ends and may be previously defined. For example, the time may be halfway through the first time period; however, it may be at other times within the first rime period. The time may be set to allow the training of the second Bloom filter 110 to capture some queries in the first time period, but not all the queries. Second Bloom filter 110 is not trained for the whole time of the first time period to limit the size of second Bloom filter 110. This reduces the item set in Bloom filter 110, which may reduce the number of false positives while keeping the efficiency of using second Bloom filter 110 by capturing the most recent repeated queries.

At 306, query processor 108 starts training second Bloom filter 110 by inserting keys into the second Bloom filter 110 that are being inserted into a first Bloom filter 110 when the first Bloom filter 110 is being used to answer queries. As discussed above, second Bloom filter 110 is not being used to answer queries; rather, first Bloom filter 110 is used to answer the queries. However, the training of second Bloom filter 110 inserts keys into second Bloom filter 110 for queries that are received during the training period.

At 308, when the first time period ends, query processor 108 starts using the trained second Bloom filter 110 to answer queries. The queries that have been received during the training period are now captured by second Bloom filter 110.

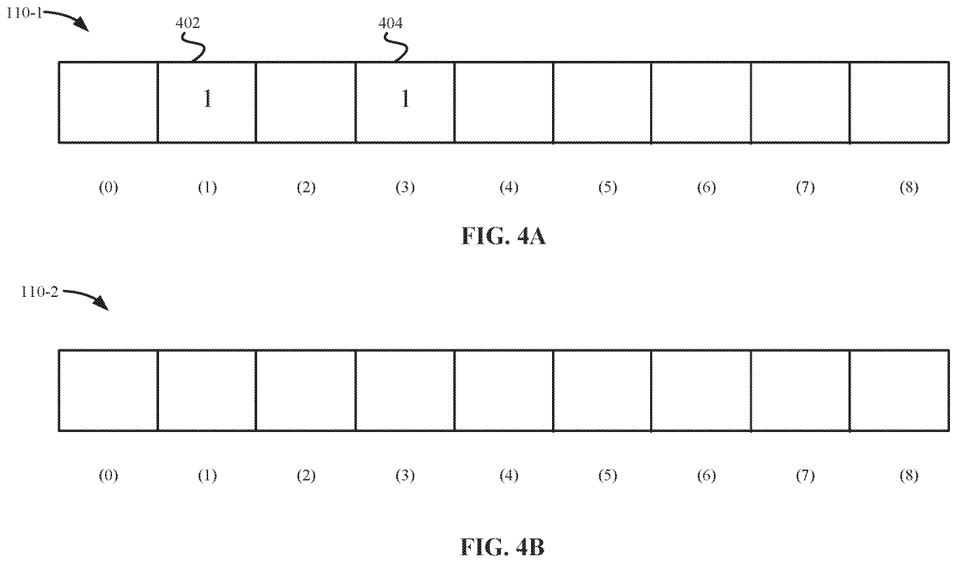

FIGS. 4A, 4B, 5A, 5B, and 6 show the contents of Bloom filters 110 during and after the training process according to some embodiments. FIG. 4A shows an example of a first Bloom filter 110-1 before the training process starts and FIG. 4B shows an example of a second Bloom filter 110-2 before the training process starts according to some embodiments. During this time, in FIG. 4A, query processor 108 may receive queries and keys for those queries are inserted into first Bloom filter 110-1. In some embodiments, the values of the keys are shown as (0), (1), . . . , (8). When query processor 108 generates one of those values, query processor 108 inserts a value into first Bloom filter 110-1 for that value. In some embodiments, the value may be “1” indicates that this key has been received before. Although the value of “1” is described, other values may be used. If a value of “0” or no value is found in first Bloom filter 110-1 for a key, then the respective key has not been received. At 402 and 404, query processor 108 has inserted the value “1” into entries in first Bloom filter 110-1, which means that the keys (1) and (3) have been received by query processor 108. Because the queries above were received before the training process for second Bloom filter 110-2 starts, second Bloom filter 110-2 remains empty in FIG. 4B and no information is inserted into second Bloom filter 110-2 that corresponds to the entries at 402 and 404 of first Bloom filter 110-1.

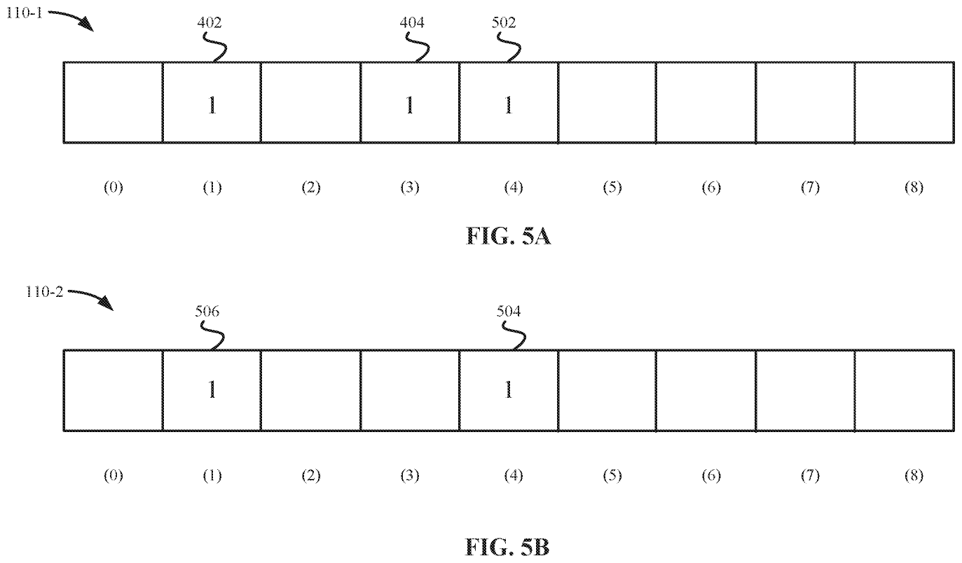

FIGS. 5A and 5B show an example of first Bloom filter 110-1 and an example of second Bloom filter 110-2 during the training process according to some embodiments. First Bloom filter 110-1 includes the values set at 402 and 404. Additionally, query processor 108 may receive another query in which the key generated is (4). Query processor 108 then inserts the value of “1” at 502 into first Bloom filter 110-1. Additionally, query processor 108 inserts the value of “1” for the key of (4) at 504 in second Bloom filter 110-2. Query processor 108 does not use second Bloom filter 110-2 to answer the query, but just inserts the value of “1” for the key in second Bloom filter 110-2. This indicates that a query has been received that is associated with the key of (4) in the training process. Also, query processor 108 may receive another query in which the key generated is (1). First Bloom filter 110-1 already includes the value of “1” at 402 and query processor 108 does not set a value in Bloom filter 110-1. However, query processor 108 sets a value in first Bloom filter 110-2 for the key (1). This indicates that query processor 108 has received the query during the training, process even though query processor 108 does not insert a value into first Bloom filter 110-1.

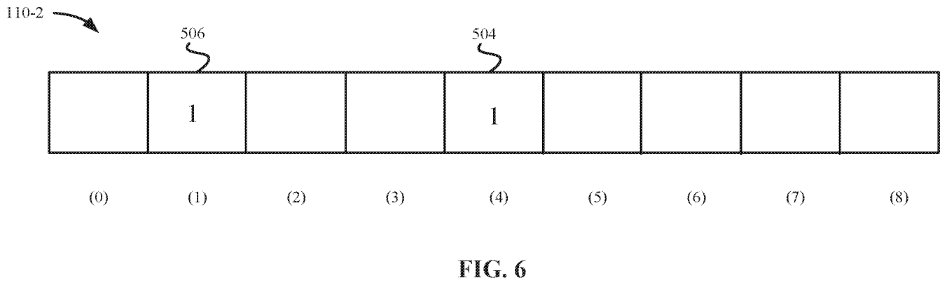

FIG. 6 depicts an example of second Bloom filter 110-2 after the training process ends according to some embodiments. At the beginning of the second time period, first Bloom filter 110-1 is not used anymore and may be discarded. Second Bloom filter 110-2 has the value for keys (1) and (4) set as “1” at 506 and 504, respectively. These values were set due to the training process described above. Any other keys may be set for queries that were received during the training process also, but are not shown. Accordingly, second Bloom filter 110-2 starts the second time period with values set for queries that were received during the training process. Now, any queries that are repeated from the training process will be reflected in second Bloom filter 110-2. Query processor 108 can then retrieve data for those repeated queries from cache 114 or may store data from database 112 in cache 114 if the data is not already stored.

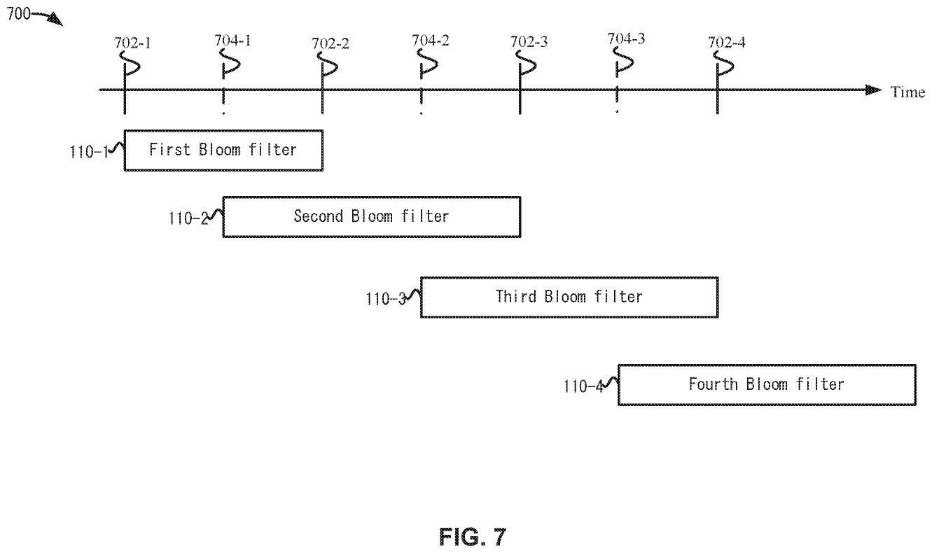

FIG. 7 depicts an example showing the training time periods according to some embodiments. At 702-1, a first time period starts. This may be the beginning time in which a first Bloom filter 110-1 is used. First Bloom filter 110-1 is used for the first time period between 702-1 and 702-2. During the first time period, at 704-1, second Bloom filter 110-2 starts to be used in the training process. The training process lasts from 704-1 to 702-2.

At 702-2, the second time period starts and query processor 108 stops using first Bloom filter 110-1, which may be discarded. Then, query processor 108 uses a second Bloom filter 110-2 to respond to queries. The use of second Bloom filter 110-2 continues for the second time period, which lasts until 702-3.

Similar to above, a training process for a third Bloom filter 110-3 starts at a time 704-2. The above process continues where at the end of the second time period at 702-3, query processor 108 stops using second Bloom filter 110-2 and starts using third Bloom filter 110-3. Query processor 108 uses third Bloom filter 110-3 until the third time period ends at 702-4. At 704-3, query processor 108 trains a fourth Bloom filter 110-4. The above process continues as Bloom filters are continually rotated to be used by query processor 108.

Conclusion

Accordingly, using rotating Bloom filters, query processor 108 can limit the size of the queries that are being recorded into the Bloom filters. Limiting the size reduces the number of false positives that may result. However, using the training process allows query processor 108 to capture the queries that have been most recently repeated. This allows query processor 108 to more efficiently respond to queries that have been recently repeated. Query server 104 can thus respond to queries more quickly while limiting false positives.

System

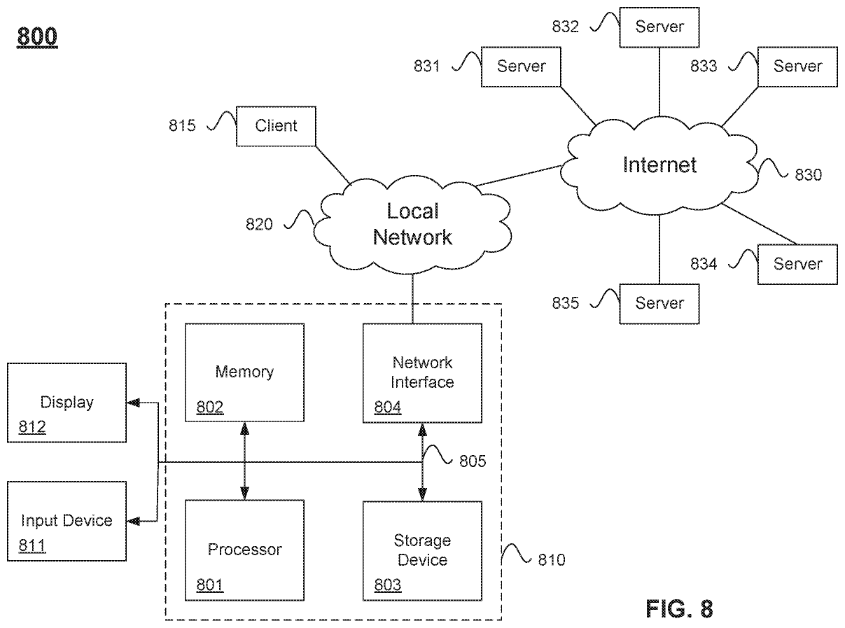

FIG. 8 illustrates hardware of a special purpose computing machine configured with query processor 108 according to one embodiment. An example computer system 810 is illustrated in FIG. 8. Computer system 810 includes a bus 805 or other communication mechanism for communicating information, and a processor 801 coupled with bus 805 for processing information. Computer system 810 also includes a memory 802 coupled to bus 805 for storing information and instructions to be executed by processor 801, including information and instructions for performing the techniques described above, for example. This memory may also be used for storing variables or other intermediate information during execution of instructions to be executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 803 may include source code, binary code, or software files for performing the techniques above, for example. Storage device and memory are both examples of computer readable storage mediums.

Computer system 810 may be coupled via bus 805 to a display 812, such as a cathode ray tube (CRT) or liquid crystal display (LCD), for displaying information to a computer user. An input device 811 such as a keyboard and/or mouse is coupled to bus 805 for communicating information and command selections from the user to processor 801. The combination of these components allows the user to communicate with the system. In some systems, bus 805 may be divided into multiple specialized buses.

Computer system 810 also includes a network interface 804 coupled with bus 805. Network interface 804 may provide two-way data communication between computer system 810 and the local network 820. The network interface 804 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 804 sends and receives electrical, electromagnetic, or optical signals that carry digital data streams representing various types of information.

Computer system 810 can send and receive information through the network interface 804 across a local network 820, an Intranet, or the Internet 830. In the Internet example, software components or services may reside on multiple different computer systems 810 or servers 831-835 across the network. The processes described above may be implemented on one or more servers, for example. A server 831 may transmit actions or messages from one component, through Internet 830, local network 820, and network interface 804 to a component on computer system 810. The software components and processes described above may be implemented on any computer system and send and/or receive information across a network, for example.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be configured to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
using, by a computing device, a first probabilistic data structure to determine whether a first set of queries have been previously received during a first time period, wherein data from a first storage device is retrieved to satisfy a query and stored in a second storage device when information in the first probabilistic data structure indicates the query is repeated;
at a time within the first time period, training, by the computing device, a second probabilistic data structure while the first probabilistic data structure is being used to determine whether queries in a second set of queries have been previously received, wherein information in the second probabilistic data structure is set for the second set of queries to indicate the second set of queries have been received; and
upon an end of the first time period, replacing, by the computing device, the first probabilistic data structure with the second probabilistic data structure, wherein the second probabilistic data structure is used to determine whether a third set of queries have been previously received for a second time period.

2. The method of claim 1, wherein using the first probabilistic data structure comprises:
receiving a first query in the first set of queries;
generating a first key for the first query based on parameters for the first query; and
inserting the first key into the first probabilistic data structure.

3. The method of claim 2, wherein using the first probabilistic data structure comprises:
receiving a second query in the first set of queries;
generating a second key for the second query based on parameters for the second query; and
determining whether the second key is stored in the probabilistic data structure.

4. The method of claim 3, wherein when the second key is a same value as the first key, the method further comprising:
retrieving data from the first storage device for the second query; and
storing data from the first storage device in the second storage device.

5. The method of claim 4, wherein when the second key is the same as the first key, the method further comprising:
receiving a third query in the first set of queries;
generating a third key for the third query based on parameters for the third query;
determining that the third key is stored in the probabilistic data structure, wherein the third key is a same value as the first key; and
retrieving the data from the second storage device that was stored for the second query to respond to the third query.

6. The method of claim 5, wherein using the first probabilistic data structure comprises:
returning the data from the second storage device without accessing the first storage device when responding to the third query.

7. The method of claim 3, wherein when the second key is not a same value as the first key, the method further comprising:
retrieving data from the first storage device for the second query; and
inserting the second key into the first probabilistic data structure.

8. The method of claim I, wherein training the second probabilistic data structure comprises:
determining when the time within the first time period occurs, the time being after the start of the first time period; and
starting the training of the second probabilistic data structure upon reaching the time.

9. The method of claim 1, wherein training the second probabilistic data structure comprises:
not using the second probabilistic data structure to respond to the second set of queries.

10. The method of claim 1, wherein the second probabilistic data structure does not include information that is set in the second probabilistic data structure for the first set of queries upon a start of the training.

11. The method of claim 1, wherein the information in the first probabilistic data structure and the second probabilistic data structure comprises a value in a position in the first probabilistic data structure and the second probabilistic data structure that represents a key that is generated from one or more parameters of the second set of queries.

12. The method of claim 1, wherein the information in the first probabilistic data structure and the second probabilistic data structure is generated by inputting parameters for a query input a function to generate a key.

13. The method of claim 1, further comprising:
before the end of the second time period, training a third probabilistic data structure while the second probabilistic data structure is being used to determine whether queries for a fourth set of queries are repeated, wherein information in the third probabilistic data structure is set for the fourth set of queries; and
upon the end of the second time period, replacing the second probabilistic data structure with the third probabilistic data structure, wherein the third probabilistic data structure includes information that is set for the third set of queries to indicate the third set of queries have been received.

14. The method of claim 1, wherein after the first time period, the first probabilistic data structure is not used for the third set of queries.

15. The method of claim 1, wherein accessing data in the second storage device is accessible faster than accessing data in the first storage device.

16. The method of claim 1, wherein the second storage device comprises local storage to the computing device and the first storage device comprises external storage to the computing device.

17. The method of claim 1, wherein the first probabilistic data structure and the second probabilistic data structure are Bloom filters that use a function to determine keys from parameters of the first set of queries and the second set of queries.

18. A non-transitory computer-readable storage medium containing instructions, that when executed, control a computer system to be configured for:
using a first probabilistic data structure to determine whether a first set of queries have been previously received during a first time period, wherein data from a first storage device is retrieved to satisfy a query and stored in a second storage device when information in the first probabilistic data structure indicates the query is repeated;
at a time within the first time period, training a second probabilistic data structure while the first probabilistic data structure is being used to determine whether queries in a second set of queries have been previously received, wherein information in the second probabilistic data structure is set for the second set of queries to indicate the second set of queries have been received; and
upon an end of the first time period, replacing the first probabilistic data structure with the second probabilistic data structure, wherein the second probabilistic data structure is used to determine whether a third set of queries have been previously received for a second time period.

19. A method comprising:
during a first time period:
receiving, by a computing device, a first query;
generating, by the computing device, a first key for the first query based on parameters for the first query; and
inserting, by the computing device, the first key into a first probabilistic data structure;
during a time in the first time period:
receiving a second query;
generating a second key for the second query based on parameters for the second query;
inserting the second key into the first probabilistic data structure when the second key has not already been inserted in the first probabilistic data structure: and
inserting the second key into a second probabilistic data structure when the second key has not already been inserted in the second probabilistic data structure,
wherein the second probabilistic data structure is used starting in a second time period after the first time period ends and the first probabilistic data structure is not used after the first time period ends.

20. The method of claim 19, further comprising:
moving data for the second query from a first storage device to a second storage device when the second key has been inserted in the first probabilistic data structure, wherein the data is used to answer queries when a query that corresponds to the second key is received again.
